(19) United States
(12) Patent Application Publication
(10) Pub. No.: US 2005/0277098 A1
(43) Pub. Date: Dec. 15, 2005

(54) Interactive clock for children

(76) Inventor: Dennis J. Schmitt, Maribel, WI (US)

Correspondence Address: WELSH & FLAXMAN LLC, 2000 DUKE STREET, SUITE 100, ALEXANDRIA, VA, 22314, US

(21) Appl. No.: 11/128,290

(22) Filed: May 13, 2005

Related U.S. Application Data
(60) Provisional application No. 60/579,456, filed on Jun. 14, 2004.

(51) Int. Cl. G09B 19/12

(52) U.S. Cl. 434/304

(57) ABSTRACT

An interactive clock includes a clock unit integrated with a timed reminder system having a central processing unit. The central processing unit is programmed to coordinate visual and audible alarms with the clock unit for providing a child with instructions for completing his or her morning routine at appropriate, predetermined times.

### CROSS REFERENCE TO RELATED APPLICATION

This application based upon U.S. Provisional Patent Application Ser. No. 60/579,456, filed May 134, 2004, entitled “INTERACTIVE CLOCK FOR CHILDREN”.

### BACKGROUND OF THE INVENTION

1. Field of the Invention

This invention relates to an interactive clock. More particularly, the invention relates to an interactive clock designed to provide children with friendly reminders regarding their daily activities.

2. Description of the Prior Art

As the pace of daily life has increased over the past few decades, the daily routines of many Americans have changed. The proliferation of dual income families and single parent families, as well as urban lifestyles and shifting demographics, has made a significant impact on our culture. Perhaps, nowhere, is this clearer than the functioning of our family units.

With the many families relying upon two incomes and others operating with only a single parent to provide for the children, the increased demands of modern life have placed pressures upon everyone, including children, within a family unit. With this in mind, the traditional parent role has been redefined. Many parents do not have sufficient time to wake their children and encourage healthy and positive behavior habits. Many mothers and fathers are simply too busy trying to manage countless things in their personal and professional lives to effectively oversee and assist their children with their daily activities. As a result, many children do not have the support and encouragement they need, especially in the morning hours.

These changes in American lifestyles have caused children to become more self-reliant. Many children wake-up each morning to a traditional alarm clock. This alerts them that their day has begun. Between waiting up and going to school, however, there are many tasks that must be completed. Children need to use the bathroom, wash-up, change clothes, brush their teeth, comb their hair, make their beds and eat breakfast, among other things. Without ensuring that these activities are performed in a timely manner, the child will not be prepared for the day. Although taken for granted by adults, these activities establish a pattern for successful behavior that follows the child throughout his or her life.

A need exists, therefore, for a system adapted for helping parents and children develop healthy and positive behavior habits. The present invention provides such a system.

### SUMMARY OF THE INVENTION

It is, therefore, an object of the present invention to provide an interactive clock including a clock unit integrated with a timed reminder system having a central processing unit. The central processing unit is programmed to coordinate visual and audible alarms with the clock unit for providing a child with instructions for completing his or her morning routine at appropriate, predetermined times.

It is also an object of the present invention to provide an interactive clock wherein the timed reminder system includes an audio alert unit.

It is another object of the present invention to provide an interactive dock wherein the timed reminder system includes a visual alert unit having a display panel.

It is a further object of the present invention to provide an interactive clock wherein the visual alert unit includes an LCD screen.

It is also another object of the present invention to provide an interactive clock where the central processing unit is preprogrammed with visual and audible alarms.

It is still another object of the present invention to provide an interactive clock wherein the central processing unit includes an input/output for reprogramming.

It is yet a further object of the present invention to provide an interactive clock wherein an expansion slot is associated with the central processing unit for use in reprogramming the central processing unit via a memory card.

It is also an object of the present invention to provide an interactive clock wherein the timed reminder system includes a visual alert unit having a display, and the interactive clock further includes integrated buttons facilitating customization of the central processing unit via a menu present on the visual alert unit.

Other objects and advantages of the present invention will become apparent from the following detailed description when viewed in conjunction with the accompanying drawings, which set forth certain embodiments of the invention.

### BRIEF DESCRIPTION OF THE DRAWINGS

FIG. 1 is a schematic of the components making up the present interactive clock.

FIG. 2 is a front view of the present interactive clock.

### DESCRIPTION OF THE PREFERRED EMBODIMENT

The detailed embodiment of the present invention is disclosed herein. It should be understood, however, that the disclosed embodiment is merely exemplary of the invention, which may be embodied in various forms. Therefore, the details disclosed herein are not to be interpreted as limiting, but merely as the basis for the claims and as a basis for teaching one skilled in the art how to make and/or use the invention.

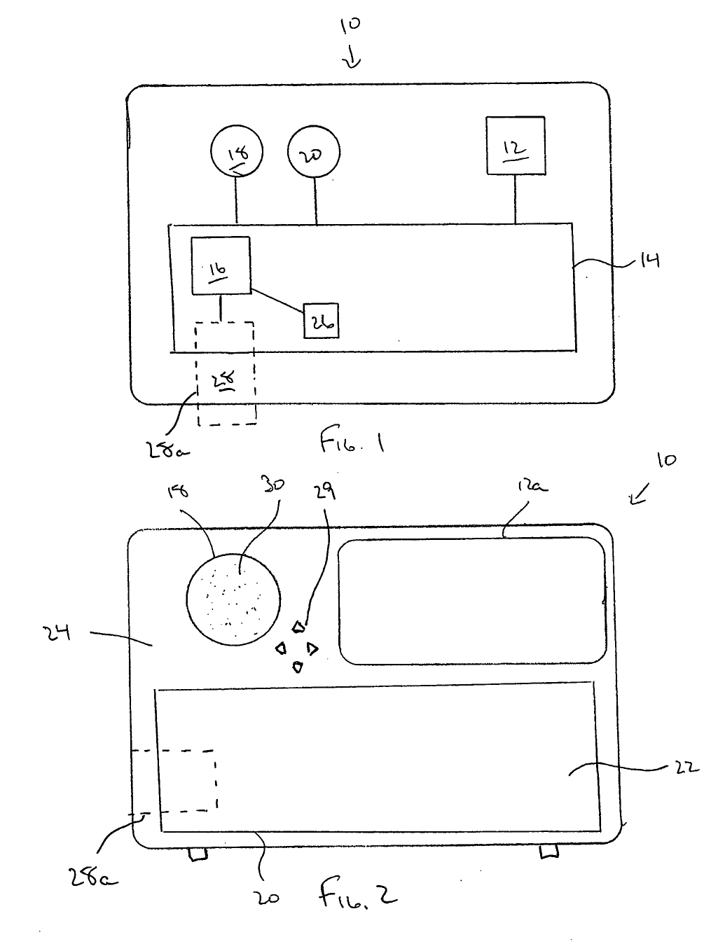

With reference to FIGS. 1 and 2, the present interactive clock 10 combines a traditional clock 12 with a timed reminder system 14. The present interactive clock 10 provides a visual and electronic program of encouragement regarding the daily activities confronting children. The present interactive clock 10 not only tells time, but also provides children, and even some adults, with an indication as to what activities need to be accomplished and coordinates these activities such that children can readily achieve successful completion of these activities within an allotted period of time.

In addition, the interactive clock 10 provides positive messages and encouragement for children. In this way, the interactive clock 10 helps take the place of a more traditional parent by encouraging children with positive reinforcement.

In accordance with a preferred embodiment of the present invention, and with reference to FIGS. 1 and 2, the interactive clock 10 includes a clock unit 12 integrated with a timed reminder system 14 having a central processing unit 16. The clock unit 12 is a traditional electronic clock and is linked to the central processor for providing the central processing unit 16 with timing information required for proper operation of the present interactive clock 10. Although the clock unit and central processing unit are disclosed in accordance with a preferred embodiment as being separate components, those skilled in the art will appreciate that the clock unit could be integrated with the central processing unit without departing from the spirit of the present invention.

The central processing unit 16 is programmed to coordinate visual and audible alarms with the clock unit 12 for providing the child with instructions for completing his or her morning routine at appropriate, predetermined times. The central processing unit 16 is, therefore, associated with an audio alert unit 18 and a visual alert unit 20 used in providing children with encouragement regarding the activities.

With regard to the audio alert unit 18, it is generally composed of a speaker system 30 providing children with spoken instructions regarding their morning activities. The visual alert unit 20 is preferably composed of a display panel 22, for example, an LCD screen, upon which images are displayed for providing instructions helping children through their morning activities, although other visual warning structures could be employed without departing from the spirit of the present invention.

The warnings provided by the central processing unit 16 are programmed to occur at predefined times during the day, in particular, during the morning preparation hours. As those skilled in the art will certainly appreciate, the programming of the central processor unit 16 may be achieved using various known techniques within the spirit of the present invention.

In accordance with a preferred embodiment of the present invention, the interactive clock 10 is designed to hang on the wall or stand on a bedside table. The device is sized to accommodate the clock unit 12, the decorative display panel 22 (functioning as part of the visual alert unit 20) and required electronics. As those skilled in the art will certainly appreciate, the clock unit 12 has a digital or analog display 12a for general checking of the present time.

The interactive clock 10 is further provided with a faceplate 24. The faceplate 24 preferably includes illustrations and is designed for girls and/or boys of various ages. It will be colorful, playful and fun to encourage children to use the interactive clock 10 as much as possible.

It is contemplated the display panel 22 of the interactive clock 10 might illustrate farm animals as they conduct the necessary morning activities, such as, eating breakfast, so as to provide playful reminders to the children that it is now time to eat breakfast. Further, and for example, a cartoon theme could be created for the display panel 22. However, and as those skilled in the art will appreciate, a variety of display themes could be employed without departing from the spirit of the present invention.

The interactive audio/visual alerts units 18, 20 may be altered for children of different ages. This is achieved by reprogramming the central processing unit 12. Reprogramming is accomplished via either an input/output 26 to the central processing unit 16 or a memory card 28 linked to the central processing unit 12 via and expansion slot 28a.

With regard to the electronic features, and specifically the central processing unit 16 and associated audio and visual alert units 18, 20, the central processing unit 16 is programmed to provide electronic voice messages played through a speaker 30. These messages are positive statements, such as, “Hey buddy, have you brushed your teeth yet?” The messages are designed to correspond with the visual image provided on the display panel 22. For example, a cartoon theme might include the voice of the leading characters.

In accordance with preferred embodiments, the audio message is coordinated with the image present on the display panel 22 and various recorded messages may be preprogrammed within the central processing unit 12 or downloaded to the central processing unit 16 using mechanisms currently available and known to those skilled in the art. For example, the visual alert unit 20 might light up the images or power the movement of characters on the display panel 22 in a coordinated manner with the audio message. When reminding the child about brushing his or her teeth, the display panel 22 image might show an animal or character doing the same task. When the display panel 22 takes the form of an LCD or electronic screen, interactive features and animation effects may be employed. The voice messages and other features could alternately be recorded on a small device, such as, a tape, disk, cartridge or flash card.

In accordance with a preferred embodiment, and as discussed above, the interactive clock 10 is programmable. As such, the parent and/or child may set the central processing unit 16 to provide the correct time and provide a time line for the various messages encouraging positive behavior by the child. It is further contemplated that the interactive clock 10 may be customized or selected by the user. As mentioned above, customization may be achieved through an input/output 26, a memory card 28 or integrated buttons 29 facilitating customization via a menu present on the display panel 22.

In addition to telling time, the present interactive clock 10 provides parents with a helpful product for assisting their children with their daily routine. It ensures responsible behavior during the day with positive reminders. The children receive the benefit of seeing and hearing interesting characters as they start their day and complete their activities.

The customizable features of the interactive clock 10, including, a display panel theme, electronics and a recorded message, help the interactive clock 10 stay current. The interactive clock 10 changes and grows with the child. The parent will simply be required to purchase and install schematic updates by simply connecting and uploading the updates to the input/output 26 or installing a memory card 28 containing the updates within the expansion slot 28a.

From barn animals to sports figures, the possibilities are far reaching as those skilled in the art will certainly appreciate. It is also proposed that versions of the interactive clock might be developed for adults. The themes might connect with popular television shows, movies, books, sports and other ideas. This version might include positive affirmations, for example, dieting advice.

While various preferred embodiments have been shown and described, it will be understood that there is no intent to limit the invention by such disclosure, but rather, is intended to cover all modifications and alternate constructions falling within the spirit and scope of the invention.

1. An interactive clock, comprising:
a clock unit integrated with a timed reminder system having a central processing unit;
the central processing unit is programmed to coordinate visual and audible alarms with the clock unit for providing a child with instructions for completing his or her morning routine at appropriate, predetermined times.

2. The interactive clock according to claim 1, wherein the timed reminder system includes an audio alert unit.

3. The interactive clock according to claim 1, wherein the timed reminder system includes a visual alert unit having a display panel.

4. The interactive clock according to claim 3, wherein the visual alert unit includes an LCD screen.

5. The interactive clock according to claim 1, wherein the timed reminder system includes an audio alert unit and a visual alert unit.

6. The interactive clock according to claim 1, where the central processing unit is preprogrammed with visual and audible alarms.

7. The interactive clock according to claim 1, wherein the central processing unit includes an input/output for reprogramming.

8. The interactive clock according to claim 1, wherein an expansion slot is associated with the central processing unit for use in reprogramming the central processing unit via a memory card.

9. The interactive clock according to claim 8, wherein the central processing unit includes an input/output for reprogramming.

10. The interactive clock according to claim 1, wherein the timed reminder system includes a visual alert unit having a display, and the interactive clock further includes integrated buttons facilitating customization of the central processing unit via a menu present on the visual alert unit.
